(19) United States
(12) Patent Application Publication
(10) Pub. No.: US 2022/0078096 A1
(43) Pub. Date: Mar. 10, 2022

(54) MANAGEMENT PORTAL WITH OBJECT PROXY FOR MONITORING AND CONTROLLING REMOTE SITES AND EQUIPMENT

(71) Applicants: Benjamin Stump, Kendall Park, NJ (US); Matthew Izzo, Little Silver, NJ (US); Brett E. Humphreys, Lewis Center, OH (US)

(72) Inventors: Benjamin Stump, Kendall Park, NJ (US); Matthew Izzo, Little Silver, NJ (US); Brett E. Humphreys, Lewis Center, OH (US)

(21) Appl. No.: 12/964,291

(22) Filed: Dec. 9, 2010

Related U.S. Application Data
(60) Provisional application No. 61/267,908, filed on Dec. 9, 2009.

(51) Int. Cl. H04L 12/26; H04W 24/08; H04L 29/06

(52) U.S. Cl. CPC H04L 43/08; H04L 67/42; H04W 24/08

(57) ABSTRACT

A shared computer network includes a plurality of servers each having a server program which creates remote objects and makes references to the remote objects accessible and a client having a client program which obtains the references to the remote objects and invokes methods on the remote objects. The client program and the server program can provide both distributed method invocation so that all of the plurality of servers receive a distributed method invocation from the client and directed method invocation so that a specific one of the plurality of servers receives a directed method invocation from the client. The client program and the server program can also provide automatic directed method request routing so that the directed method invocation is transparently routed to a correct one of the plurality of servers.

### CROSS-REFERENCE TO RELATED APPLICATIONS

This application claims the priority benefit of U.S. Provisional Patent Application No. 61/267,908 filed on Dec. 9, 2009, the disclosure of which is expressly incorporated herein in its entirety by reference.

### STATEMENT REGARDING FEDERALLY SPONSORED RESEARCH

Not Applicable

### PARTIES TO JOINT RESEARCH AGREEMENT

Not Applicable

### REFERENCE TO APPENDIX

Not Applicable

### FIELD OF THE INVENTION

The field of the invention generally relates to shared computer networks and, more specifically, to management systems for monitoring and controlling remote sites and equipment such as systems used to monitor and control cell sites of wireless telecommunication networks.

### BACKGROUND OF THE INVENTION

Wireless telecommunication networks typically have central management stations which manage and control a plurality of remote sites. Devices at the remote sites collect analog sensor measurements and provide that information to the central management station. For example, see U.S. Pat. Nos. 6,640,101 and 7,567,519, the disclosures of which are expressly incorporated herein in their entireties.

This information provided to the central management station from the remote sites is often limited such as, for example, to current or voltage measurements taken as analog inputs, internal temperatures, and incoming power voltages. While this information from the remote sites can provide a wealth of information about the remote sites, it does not help anticipate or resolve many problems at the remote cites. Additionally, there is an ongoing and increasing desire to reduce the number of occasions that it is necessary to send maintenance personnel to the remote sites.

Accordingly, there is a need in the art for improved management systems for monitoring and controlling remote sites and equipment.

### SUMMARY OF THE INVENTION

Disclosed herein is a management system for monitoring and controlling remote sites and equipment which addresses one or more issues in the related art. Disclosed herein is a shared computer network comprising, in combination, a plurality of servers each having a server program which creates remote objects and makes references to the remote objects accessible, and a client having a client program which obtains the references to the remote objects and invokes methods on the remote objects. The client program and the server program provide both distributed method invocation so that all of the plurality of servers receive a distributed method invocation from the client and directed method invocation so that a specific one of the plurality of servers receives a directed method invocation from the client.

Also disclosed herein is a shared computer network comprising, in combination, a plurality of servers each having a server program which creates remote objects and makes references to the remote objects accessible, and a client having a client program which obtains the references to the remote objects and invokes methods on the remote objects. The client program and the server program provide directed method invocation so that a specific one of the plurality of servers receives a directed method invocation from the client. The client program and the server program also provide automatic directed method request routing so that the directed method invocation is transparently routed to a correct one of the plurality of servers.

Also disclosed herein is a shared computer network comprising, in combination, a plurality of servers each having a server program which creates remote objects and makes references to the remote objects accessible, and a client having a client program which obtains the references to the remote objects and invokes methods on the remote objects. The client program and the server program provide both distributed method invocation so that all of the plurality of servers receive a distributed method invocation from the client and directed method invocation so that a specific one of the plurality of servers receives a directed method invocation from the client. The client program and the server program provide directed method request routing so that the directed method invocation is transparently routed to a correct one of the plurality of servers.

From the foregoing disclosure and the following more detailed description of various preferred embodiments it will be apparent to those skilled in the art that the present invention provides a significant advance in the technology of management systems for monitoring and controlling remote sites and equipment. Particularly, the invention(s) disclosed herein provides a system with easy access to expanded information about remote sites. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of a management system for monitoring and controlling remote sites and equipment according to the present invention:

FIG. 2 is a diagrammatic view of a first remote device of the system of FIG. 1.

FIG. 3 is a diagrammatic view of a second remote device of the system of FIG. 1;

FIG. 4 is a diagrammatic view of a third remote device of the system of FIG. 1;

FIG. 5 is a diagrammatic view of class structure of a management portal of the system of FIG. 1;

FIG. 6 a diagrammatic view of client sequence of the management portal of the system of FIG. 1, wherein for brevity sake a Proxy object is not shown;

FIG. 7 is a diagrammatic view of server class of the management portal of the system of FIG. 1; and

FIG. 8 is a diagrammatic view of a distributed object application based on Java RMI.

### DETAILED DESCRIPTION OF CERTAIN EXEMPLARY EMBODIMENTS

It will be apparent to those skilled in the art, that is, to those who have knowledge or experience in this area of technology, that many uses and design variations are possible for the systems and methods disclosed herein. The following detailed discussion of various alternative and preferred embodiments will illustrate the general principles of the invention with regard to management of remote cell sites of wireless communication networks. Other embodiments of the present invention suitable for other applications will be apparent to those skilled in the art given the benefit of this disclosure such as, for example, shared computer networks in other applications.

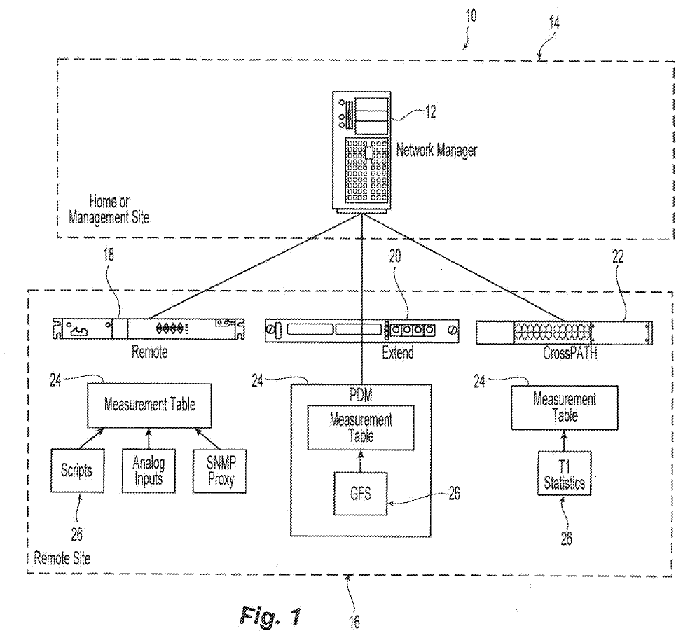

FIG. 1 illustrates a management system 10 for remote cell sites of a wireless communication network according to the present invention. The illustrated management system 10 includes a network manager 12 located at a home or management site 14 and at least one remote site 16 typically having a tower, antenna and related equipment. It is noted that while the illustrated management system 10 shows a single remote site 16, in practice there will typically be a plurality of remote sites located over a wide area. The illustrated remote site 16 includes three monitoring units or devices 18, 20, 22 with each having a measurement table 24 managed by the same network manager 12 located at the home site 14. It is noted, however, that the remote site 16 can alternatively have any other suitable quantity of monitoring units managed by the network manager 12. The monitoring units 18, 20, 22 support different types of measurements fed from downstream sources or equipment 26 at the remote site 16 that are specific to the features of the particular monitoring unit 18, 20, 22. The illustrated remote site 16 includes a first monitoring unit 18 for providing IP management to the remote site 16, a second monitoring unit 20 for monitoring and diagnosing multi-vendor wireless repeaters and mobile network assets at the remote site 16, and a third monitoring unit 22 for managing cell site WAN access at the remote site 16. It is noted, however, that any other suitable type of monitoring units can alternatively be utilized. Some monitoring units, like the first and third illustrated monitoring units 18, 22, implement the measurement table 24 as a native component of the monitoring device. Other monitoring units, like the illustrated second monitoring unit 22, implement the measurement table 24 as an external component, e.g. a script on an extend card. The interface to the network manager 12, however, is as identical as possible across the various monitoring units 18, 20, 22. See U.S. application Ser. No. 12/950,265, the disclosure of which is expressly incorporated herein in its entirety by reference, for a more detailed description of the measurement tables 24.

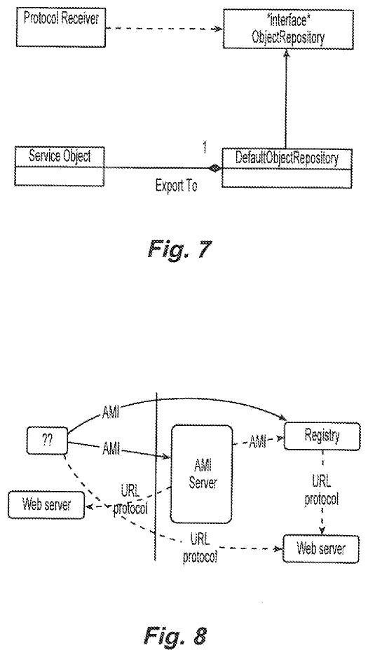

The network manager 12 is located at the home site 14 and includes a computer system having a processor and memory configured to perform the management functions described herein. The computer system also includes suitable bi-directional communication means for communicating with the monitoring units at the remote sites via Ethernet, T1/E1, and/or wireless communication options. Management software with a suitable user interface is operable with the computer system. The management portal can be Optima® Management Portal available from Kentrox, Inc., of Dublin, Ohio, but it is noted that any other suitable management software can alternatively be utilized. The Optima® Management Portal is a hybrid network management/element management software package used to monitor and provide management access to Kentrox, Inc. products deployed in the user's network. The management software preferably gives network operators a complete, 360 degree view and control of the remote sites 16. The management software provides preventative maintenance tools to help identify issues at the remote sites 16 before they occur. The management software also preferably provides performance reporting to enable operators to view trending and availability of the remote sites 16. Truck rolls to the remote sites 16 can be eliminated because of the remote access, diagnostics, and control capabilities in the management software. The main functions of the management software include: performance management; event management; element management; remote access; and site data collection and control. FIG. 7 shows an exemplary dashboard 28 for the management portal and FIG. 9 shows an exemplary graphical user interface 30 for input.

The illustrated monitoring units 18, 20, 22 are located at the remote site 16 and each include a processor and memory configured to receive definitions of measurements and alarms to be collected at the remote site 16 and to store the definitions of the measurements and alarms, a plurality of port connectors for communicating the processor with downstream collection devices that collect the measurements and alarms at the remote site 16, and a communication system for reporting the collected measurements and alarms to upstream systems such as the network manager 12. The definitions for the alarms and measurements can be provided from the port connections, stored script processes, and SNMP proxy. The memory is preferably configured to automatically store a history of the measurements and alarms collected which can be exported to the upstream systems such as the network manager 12. The processor is preferably configured to collect derived measurements not directly collected from the downstream collection devices 26 which are being monitored. Examples of derived measurements include fuel theft, battery life, optimal recycle period, power consumption, incomplete fueling detection, and the line. The processor is preferably configured to receive a maximum number of definitions for measurements and alarms and the maximum number can selectively be any combination of measurements and alarms. For example, if the maximum number of definitions is 20, there can be 1 to 20 measurements and 1 to 20 alarms as long as the total of measurements and alarms is not greater than 20. The processor is also preferably configured to identify the downstream collection devices 26 associated with each of the reported measurements and alarms. The processor is further preferably configured to receive identification information or definitions dynamically from a user, directly from smart downstream collection devices, and from an internal script or software process. Examples of definitions defined dynamically by a user include battery and generator run times. Examples of definitions defined by a device includes generator running. An example of definitions defined by internal script or software includes fuel theft. FIG. 9 shows an exemplary graphical user interface 30 for input. The processor and memory are preferably configured to determine and store minimum, maximum, and average values for each of the measurements. The processor and memory are also preferably configured to detect an out of storage or memory condition and in response, to delete the oldest stored measurement data in response to the out of storage condition. The illustrated monitoring units 18, 20, 22 including the processor, port connectors, and the communication system are packaged as a single unit, that is, all packaged within a single housing or case. It is noted that alternatively, each of these functions can reside only in the first monitoring device 18 with the second and third monitoring devices 20, 22 connected thereto. Connected in this manner, the above-described processing and storage takes place only within the first monitoring device 18 from date collected by the first, second and third monitoring devices 18, 20, 22.

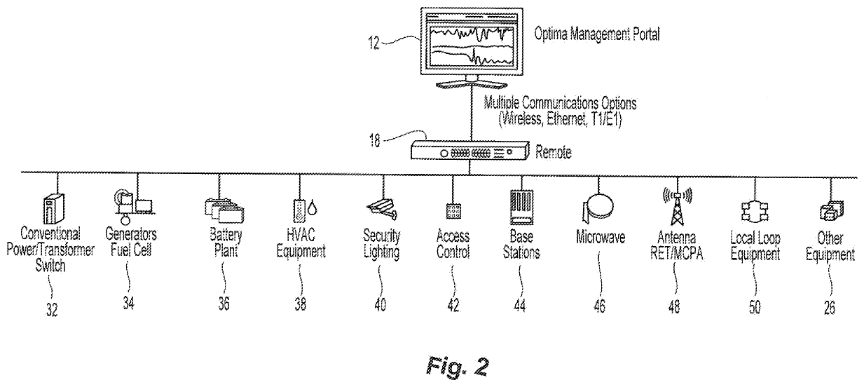

As best shown in FIG. 2, the first monitoring unit 18 is a monitoring and control device that provides IP management to remote sites and equipment. The first monitoring unit 18 can be a Remote Site Management Appliance (Remote) product available from Kentrox, Inc., of Dublin, Ohio, but it is noted that any other suitable monitoring device for providing IP management to remote sites can alternatively be utilized. The Remote product provides network connectivity and data collection for a number of network devices and sensors at a remote location. The first monitoring unit 18 provides site alarm monitoring, protocol conversion and equipment connectivity and acts as an intelligent extension of an Operations Support System (OSS). The first monitoring unit 18 enhances the network management strategy, reduces operational costs, and improves operational efficiency with reduced truck rolls to the remote site. The first monitoring unit 18 resides at the remote site 16 and connects to each desired element or piece of equipment 26 at the remote site 16 via a suitable interface. The first monitoring unit 18 performs protocol mediation and interface conversion, collects alarms and monitoring data, and supports bi-directional management control with the management portal of the network manager 14 via Ethernet, T1/E1, and/or wireless communication options. Together, the first monitoring unit 18 and the network manager 14 provide detailed monitoring, remote control, and management for virtually all of the equipment located at the remote site 16. The illustrated first monitoring device 18 is connected to downstream collection devices 26 including temperature sensors for measuring temperature readings at various locations and equipment, commercial power/transfer switches 32, generator/fuel cell controllers for measure voltage and/or strength 34, and battery strings 36 for measuring voltage and strength, HVAC equipment 38, security/lighting systems 40, access control systems 42, base station systems 44, microwave systems 46, Antenna/RET/MCPA systems 48, local loop equipment 50, and other suitable equipment and systems. It is noted, however, that the first monitoring device 18 can alternatively be connected to any other suitable downstream collection device 26.

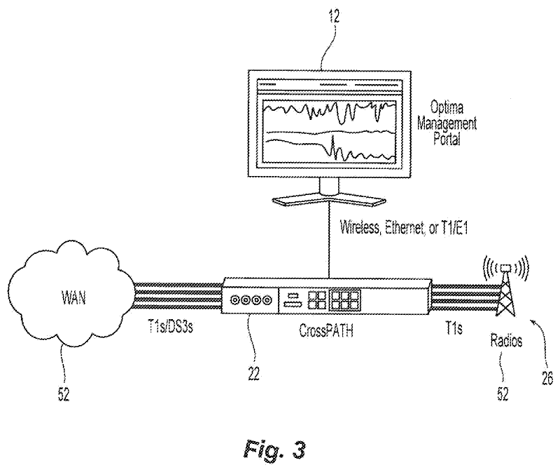

As best shown in FIG. 3, the third monitoring unit 22 provides high-capacity cell-site connectivity for the growth of existing networks and migration to higher densities. The third monitoring unit 22 can be a CrossPATH product available from Kentrox, Inc., of Dublin, Ohio, but it is noted that any other suitable monitoring device for managing cell site WAN access can alternatively be utilized. The third monitoring unit 22 offers extensive remote management tools that reduce on-site technician visits and improve network quality and customer satisfaction. The third monitoring unit 22 supports bi-directional management control with the management portal of the network manager 14 via Ethernet, T1/E1, and/or wireless communication options. Together, the third monitoring unit 22 and the network manager 12 provide real-time dashboard views of WAN conditions to allow telecommunication carriers to proactively diagnose and repair potential network problems at any given time, anywhere in the world-before they have an impact on subscribers and operating costs. The illustrated third monitoring device 22 is connected to downstream collection devices 26 including backhaul 52 for measuring circuit alarms and/or access circuit signal levels. It is noted, however, that the third monitoring device 22 can alternatively be connected to any other suitable downstream collection device 26.

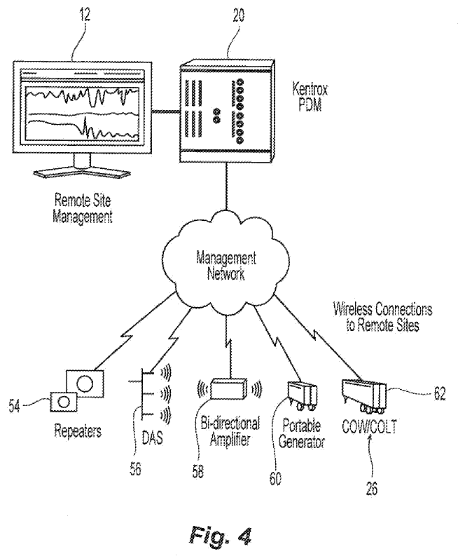

As best shown in FIG. 4, the second monitoring unit 20 enables service providers to monitor and diagnose multi-vendor wireless repeaters and mobile network assets to reduce network outages and mean time to repair (MTTR). The second monitoring unit 20 can be a Polled Device Monitor (PDM) product available from Kentrox, Inc., of Dublin, Ohio, but it is noted that any other suitable monitoring device for monitoring and diagnosing multi-vendor wireless repeaters and mobile network assets can alternatively be utilized. The PDM product is based on the architecture of the Remote product that provides a central monitoring service for small customer premise wireless network equipment. The second monitoring unit 20 supports bi-directional management control with the management portal of the network manager 12 via Ethernet, T1/E1, and/or wireless communication options. The second monitoring unit 20 preferably also supports mobile asset monitoring for portable generators, cell sites on wheels (COW) and cell sites on trucks (COT) which, due to mobility, often have limited network monitoring capabilities. Mobile asset monitoring enables operators to proactively manage remote assets by monitoring usage, network status, location issues and performance. The second monitoring unit can improve placement efficiencies and usage of mobile assets, as well as record keeping and reporting. The illustrated second monitoring device 20 is connected to downstream collection devices 26 including in-building repeaters 54 for reporting alarm conditions and/or uplink/downlink bytes, and distributed antenna systems (DAS) 56 for reporting temperature and/or signal strength, bi-directional amplifiers 58, portable generators 60, and COW/COLTs 62. It is noted, however, that the second monitoring device 20 can alternatively be connected to any other suitable downstream collection device 26. It is noted that the second monitoring unit 20 can be collocated with the first monitoring unit 18 at the remote site 16 or at a distant site such as the home site 14 depending on the environment and usages.

The illustrated management portal software or program includes object proxy which is a transport independent (TI) remote procedure call (RPC) package. RPC is an inter-process communication technology that allows a computer program to cause a subroutine or procedure to execute in another address space (commonly on another computer on a shared network) without the programmer explicitly coding the details for this remote interaction. That is, the programmer writes essentially the same code whether the subroutine is local to the executing program, or remote. TI-RPC enables developers to use different transport layer protocols in designing RPC-based applications. The transport independence of RPC isolates the application from the physical and logical elements of the data communications mechanism and enables the application to use a variety of transports. Object proxy is preferably based on distributive object application such as, for example, Java Remote Method Invocation (RMI) and the RMI Library.

Distributive object applications such as RMI often comprise two separate programs, a server, and a client. A typical server program creates some remote objects, makes references to these objects accessible, and waits for clients to invoke methods on these objects. A typical client program obtains a remote reference to one or more remote objects on a server and then invokes methods on them. RMI provides the mechanism by which the server and the client communicate and pass information back and forth. Applications can use various mechanisms to obtain references to remote objects. For example, an application can register its remote objects with RMI's simple naming facility, the RMI registry. Alternatively, an application can pass and return remote object references as part of other remote invocations. Details of communication between remote objects are handled by RMI. To the programmer, remote communication looks similar to regular Java method invocations. Because RMI enables objects to be passed back and forth, it provides mechanisms for loading an object's class definitions as well as for transmitting an object's data. FIG. 8 illustrates an RMI distributed application that uses the RMI registry to obtain a reference to a remote object. The server calls the registry to associate or bind a name with a remote object. The client looks up the remote object by its name in the server's registry and then invokes a method on it. FIG. 8 also shows that the RMI system uses an existing web server to load class definitions, from server to client and from client to server, for objects when needed.

A distributed application built using Java RMI is made up of interfaces and classes. The interfaces declare methods. The classes implement the methods declared in the interfaces and. perhaps, declare additional methods as well. In a distributed application, some implementations might reside in some Java virtual machines but not others. Objects with methods that can be invoked across Java virtual machines are typically called remote objects. An object becomes remote by implementing a remote interface. RMI creates a remote object differently from a non-remote object when the object is passed from one Java virtual machine to another Java virtual machine. Rather than making a copy of the implementation object in the receiving Java virtual machine, RMI passes a remote stub for a remote object. The stub acts as the local representative, or proxy, for the remote object and basically is, to the client, the remote reference. The client invokes a method on the local stub, which is responsible for carrying out the method invocation on the remote object. A stub for a remote object implements the same set of remote interfaces that the remote object implements. This property enables a stub to be cast to any of the interfaces that the remote object implements. However, only those methods defined in a remote interface are available to be called from the receiving Java virtual machine.

Object proxy provides infrastructure for property based invocation, remote references, naming, virtual services and routing. The transport can then be defined independently of these features. For example it is possible to utilize object proxy over a messaging infrastructure like JMS or utilize a point to point protocol like Java RMI or XMLRPC. Further, object proxy provides a set of facade like interfaces such that it can be used as a drop in replacement for things like Java RMI or XMLRPC. Before any features can be defined, some terms must be defined. A “service” is provided by a Java Object that has been exported. Services typically provide methods that can be invoked, along with other metadata upon the service. An “object repository” allows a service to be exported and available for invocation. The object repository typically will provide the transport infrastruction for the server portion of this client server conversation.

Object proxy preferably includes the features of property based invocation, remote references without server sockets, naming, virtual service, and routing. With property based invocation, a service can be discovered and have methods invoked upon it based on properties that it provides upon exporting and the caller provides upon invocation. A major drawback to Java RMI is that remote references typically mean a server socket needing to be created for such a reference to be called. Object proxy provides a layer of independence such that it is possible to not need a server socket to provide remote references. The general concept of naming comes from Java RMI. It allows the caller of a remote service to look up an instance by name and produce a remote reference to it. Object proxy supports such a request. This is used in conjunction with the property based invocation feature described above, where the name represents a set of known properties that are actually retrieved. A virtual service is one that, while not provided directly by the object repository, is handled by the repository and then delegated from. This allows for clients to interact with a small set of central servers, which can then delegate to a farm of worker servers. Along with virtual services and property based invocation, the routing feature allows a client to invoke a method on a virtual service, the virtual service then immediately delegates to a particular service on a different server based on data provided in the invocation, metadata on the interface and properties used during export by the delegate service.

Message Passing At a very high level, the object proxy framework operates on two objects. The com.kentrox.objectproxy.common.WorkUnit object provides a description of work that the service should perform and what service should perform it. The com.kentrox.objectproxy.common.Result object provides the result of the invocation of that WorkUnit. The Result object can either hold an object to represent the return value, or in the case of an error condition, a throwable. All other objects work on those fundamental objects to invoke or return the result of a method invocation.

Property Based Services A service is an object that can fulfill WorkUnit requests and create Result objects. A service is associated to a set of properties (metadata) about that object and its context. These properties are crucial to the inner workings of this framework. A WorkUnit provides a set of properties that allows selective fulfillment of the WorkUnit request. Two objects may have the exact same interface, but with the use of this metadata method can be invoked on both at different times for different requests, seamlessly. For example, two objects may implement the com.example.Printer interface. However, one has a set of properties declaring that it does duplexing, while another has a set of properties that declare it can print in color. Both perform the print (Document) operation, however the WorkUnit can help filter which one of these implementations are chosen to have their print method invoked.

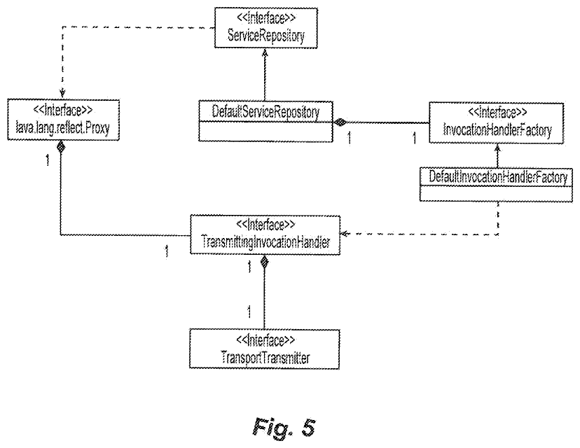

Client Transmission The object proxy framework anticipates that the client would request a remote reference to a service that could perform various tasks. The com.kentrox.objectproxy.servicerepository.ServiceRepository class provides an interface for such requests. The service repository will return a java.lang.reflect.Proxy (Proxy) of an interface based on a defined interface and a set properties provided by the client. A Proxy requires a java.lang.reflect.InvocationHandler to be provided to it handles all the proxying magic. The com.kentrox.objectproxy.common.TransmittingInvocationHandler is the base interface for all object proxy invocation handlers. This type of handler holds the interface(s) and properties that the Proxy was originally created with, along with a transmitter that performs the network I/O. At this point these classes make up the fundamental infrastructure the client needs to perform remote invocations. However object proxy is very late binding. So no network I/O has gone on yet, and there is no guarantee that a remote implementation exists that will satisfy the properties and interfaces specified by the caller. Upon each method invocation these constraints will be sent on the network to determine who should and can satisfy them. It is very possible that the same exported remote instance will be able to satisfy some calls given a set of constraints but not all calls given that same set of constraints. Each invocation stands on its own as two what object responds to it. A com.kentrox.objectproxy.TransportTransmitter class is used to perform the protocol transmission of an invocation. This interface is typically implemented by a particular protocol implementation such as JMS or XMLRPC. The TransportTransmitters sole responsibility is to take a WorkUnit and return the Result of that request (if there is any). Upon method invocation the TransmittingInvocationHandler creates a WorkUnit out of the interface(s), properties, method being invoked, and parameters to that method invocation. It sends this WorkUnit to the TransportTransmitter for transmission. For each of the classes defined above, they are typically an interface, and there is a typically a Default version of this interface defined in a subpackage. For example, ServiceRepository has a concrete implementation in com.kentrox.objectproxy.scrvicerepository.impl.DefaultServiceRepository. FIG. 5 shows the basic class structure necessary for client operation.

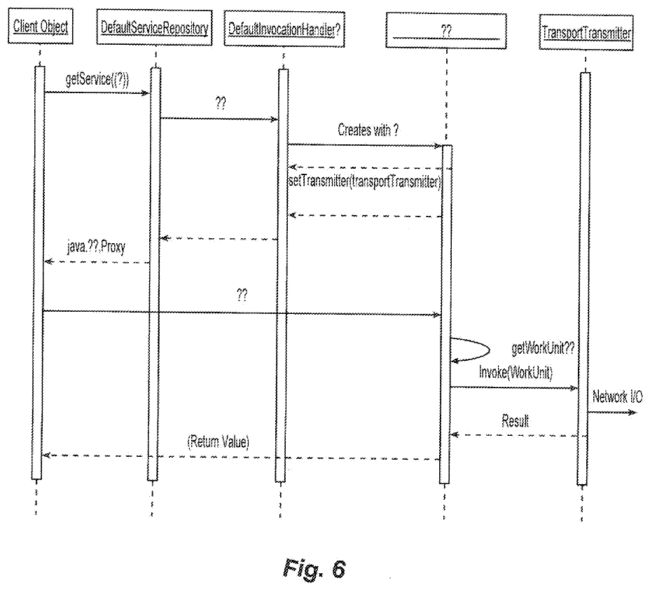

FIG. 6 is a basic sequence diagram showing what happens during a method invocation. For brevity sake the Proxy object is not shown. However, it can be assumed for any method invocation the Proxy object simply delegates to the TransmittingInvocationHandler shown.

Server invocation The server perspective is a much simpler view. The main class here is the com.kentrox.objectproxy.common.ObjectRepository interface. This interface (and its ‘default’ counterpart com.kentrox.objectproxy.common.impl.DefaultObjectRepository) has three main responsibilities: (1) Export & Unexport of Services; (2) Invocation of WorkUnit objects and creation of the appropriate Result objects; and (3) Providing queryable information about the exported objects. Typically there will be a protocol peer to the TransportTransmitter to receive the WorkUnits. This peer will then call into the ObjectRepository for invocation and results. It is up to the ObjectRepository to find the object to service the WorkUnit, invoke it, and create the appropriate Result object from the invocation. FIG. 7 shows this class diagram. The object “Protocol Receiver” is not defined as it is left for protocol specific implementations. The intent of this object is that it would pull WorkUnit objects off the wire and call the ObjectRepository.invoke method given the WorkUnit. The object “Service Object” is meant to be a place holder for exported objects that provide services.

Callbacks When an object is exported, a unique ID (UUID) is generated for that object, and is tied to the lifetime of that object's remote export. Upon method invocation (on the client side) the arguments to a method are inspected, if within the arguments there is an exported object, the object is not serialized, instead a com.kentrox.objectproxy.common.CallbackIdentifiers object is created with the UUID identifying this object. When a remote reference is desired, the client side must now house an ObjectRepository since it handles invocation of remote objects. Remote references imply that a client will act as both a client (transmitter of WorkUnit objects) and a server (a receiver of WorkUnit objects and creator of Result objects). This complicates matters in the class hierarchy as well as the DefaultTransmittingInvocationHandler which is responsible for creating the WorkUnit for an invocation must now have a reference to an ObjectRepository to determine if an object has been exported or not. Further, this framework and architecture implies that an exported object always desires to be passed as a remote reference and not as a serialized copy. Upon reception of a WorkUnit the DefaultObjectRepository inspects the arguments associated with the method invocation the WorkUnit represents. If any of these arguments are CallbackIdentifiers then a proxy is created for this object with parameters of the UUID. This implies that to handle callbacks an ObjectRepository must be provided with an InvocationHandlerFactory to produce the appropriately constrained Proxy object for invocation.

An example illustrating this is now provided. The example includes a simple remote observer pattern between two objects, com.example.server.EventSubject (the event producer) and com.example.client.EventObserver (the event receiver). Two processes are references ‘A’ the producer process and ‘B’ the observer process. The steps are:
1. An instance of EventSubject is exported in process A.
2. Process B creates a Proxy for EventSubject.
3. An instance of EventObserver is exported in process B. Upon exporting a UUID of ‘55564-4453’ is created and associated with this object.
4. When process B invokes the attach(EventObserver) object on EventSubject The following happens:
   a. The DefaultTransmittingInvocationHandler inspects the list of 1 argument.
   b. It queries its object repository and determines that argument 1 (the EventObserver) has been exported as a remote object.
   c. It then gets the EventObservers UUID of “55564-4453” and creates a Callback Identifier object
   d. When creating the WorkUnit it sets the created CallbackIdentifier as argument 1, not the EventObserver.
5. Process B's transport transmitter then puts the created WorkUnit onto the wire.
6. Process A's ObjectRepository then receives this WorkUnit and inspects it
   a. It determines that the first argument is a CallbackIdentifier
   b. It creates a Proxy and uses the UUID contained within the identifier to create the TransmittingInvocationHandler
7. Process A then invokes the method on EventSubject which stores this created Proxy in some collection
8. Some point later process A's EventSubject needs to call update (Event) on all the EventObservers currently registered. When it gets to the remote event observer, this will:
   a. Create a WorkUnit for the invocation
   b. The WorkUnit will contain a set of constraints such that only the object associated with UUID ‘55564-4453’ can service this request.
   c. It then transmits this WorkUnit onto the wire.
9. Process B's ObjectRepository then sees this WorkUnit and filters the constraints to the one object that is associated with that UUID, and invokes the update method on that exported object.

Naming The com.kentrox.objectproxy.common.Naming interface provides a simple lookup for a string name to a set of properties. These properties can then be used from with the ServiceRepository to create a Proxy instance.

Advisors Advisors are used in a variety of places to provide customized behavior. The idea with these advisors is akin to extensions or aspects. Typically these advisors are queried that would change some behavior based on what the advisor knows. There is some sane default behavior, however once advised significant behavioral changes can take place. A couple very important advisors are detailed below.

com.kentrox.obiectproxy.common.MethodInvocationAdvisor This advisor is used by an ObjectRepository to determine how to handle an invocation, particularly whether it should be delegated, handled locally, or handled at all.

com.kentrox.objectproxy.common.InterfaceExportAdvisor This advisor is used by an ObjectRepository to determine the exportable interfaces by which an exported object might be known by.

com.kentrox.objectproxy.common.ExceptionAdvisor This advisor is used by the DefaultTransmittingInvocationHandler to determine what exceptions due to network I/O errors should look like. For example, it may need to look like an unchecked runtime exception, or a checked java.rmi.RemoteException.

Routing and Virtual Services Routing and virtual services are one of the strongest points to this framework. Virtual services are simply exported interfaces. Invocations to these services are never handled by any application level code. Invocation is done completely in the ObjectRepository where the virtual service was exported. A virtual service is simply defined by an interface and a set of properties. Whereas a concrete service is defined by an object which implements a set of interfaces and a set of properties. Upon invocation of a virtual service, the ObjectRepository which exports that service should seek to delegate that invocation to another server via the routing functionality.

With regard to routing, when an ObjectRepository encounters a virtual service, it seeks to add extra properties onto the WorkUnit. These extra properties will define what ObjectRepository this WorkUnit is ultimately destined for. The ObjectRepository will rely on a MethodInvocationAdvisor to provide these properties.

Functionally the following will typically be performed during a virtual service invocation:
1. A virtual service will be exported for interface com.example.A on ObjectRepository 1. This export will have very few constraining properties.
2. A first concrete instantiation of an object implementing com.example.A will be exported in ObjectRepository 2. This implementation will have some constraining properties on it.
3. A second concrete instantiation of an object implementing com.example.A will be exported in ObjectRepository 3. This implementation will have some constraining properties on it.
4. The client will send a WorkUnit for a method on A that the will be matched by the virtually exported service. ObjectRepository 1 will then:
a. Ask its MethodInvocationAdvisor for further routing properties
b. Add these added properties to the WorkUnit previously received.
   will use an internal TransportTransmitter to transmit this new WorkUnit for some other ObjectRepository to invoke.

With regard to routing Metadata, the MethodInvocationAdvisor provides the ability to gather extra properties on a method to further route it. The com.kentrox.objectproxy.common.impl.AnnotationMethodInvocationAdvisor is one such implementation of this advisor. This advisor honors the com.kentrox.objectproxy.common.ServiceMeta Java annotation that provides information surrounding the method. This annotation identifies a ‘distributionIdentifier’ which is an index in the method invocation's argument list to help route this method call. Once that identifier is determined, and the index is looked up the advisor uses a routing map to get a value for the ObjectRepository that this message should be delegated to. This property is then added to the WorkUnit and transmitted for further invocation.

Concurrency The concurrency package is envisioned to provide some help understanding what ‘resources’ are being modified during remote method execution. The concept was to help provide hints to the ObjectRepository (specifically the com.kentrox.objectproxy.common.ObjectMethodInvoker) on how to properly thread the requests coming in. Resources are a generic concept that might be a RDBMS database, or just a simple hashmap in memory. A method can declare that it either reads or writes to this resource, and a simple reader/writer lock pattern is used. A write lock declaration guarantees an exclusive lock on the resource, such that no method that needs access to that resource will be invoked during the invocation of the write lock method. Further, a read lock means that multiple readers can be in that method at any one time.

Facades The facade package (com.kentrox.objectproxy.facade) is meant to provide a facade interface layer to help the object proxy framework look like another framework. The most obvious example of this is the java.rmi package for which a facade was written. The following classes are provided in this facade to make object proxy a drop-in replacement for java.rmi.

com.kentrox.objectproxy.facade.rmi.RemoteExceptionAdvisor This advisor is used to throw java.rmi.RemoteExceptions for unhandled exceptions.

com.kentrox.objectproxy.facade.rmi.BasicRegstry This object is used for objects that require a java.rmi.registry.Registry object for lookups. This object delegates to a com.kentrox.objectproxy.common.Naming instance.

com.kentrox.objectproxy.facade.rmi.RemoteInterfaceMarkerAdvisor This advisor is used by an ObjectRepository to determine if an interface is exportable. java.rmi dictates that only objects that extend java.rmi.Remote can be exported, this advisor guarantees that.

Java Message Service (JMS) Implementation Conceptually the JMS implementation is very simple. The com.kentrox.objectproxy.jms.JMSClientTransportTransmitter translates a WorkUnit into a javax.jms.ObjectMessage. It also puts all the WorkUnit properties into properties of the JMS message, this allows for efficient filtering by the JMS Broker itself before being delivered to any ObjectRepository. The JMSClientTransportTransmitter then sets up a temporary queue, the identity of which it sets the standard JMSReplyTo field to. It then waits for a response (in the form of an ObjectMessage with a payload of a Result object) to that WorkUnit on that temporary queue. The com.kentrox.objectproxy.jms.JMSFilteringObjectRepository extends DefaultObjectRepository and listens to messages on a known topic that the JMSClientTransportTransmitter publishes to. Upon invocation completion it transmits the Result object to the JMSReplyTo destination provided in the original JMS message that the WorkUnit was delivered in. Since JMS is not a point to point protocol, the JMS package provides an object called com.kentrox.objectproxy.jms.JMSAcker. This object sends a very small ACK style message on the JMSReplyTo destination for every WorkUnit that is currently being worked upon. These ACKs are then honored by the JMSClientTransportTransmitter such that it knows some ObjectRepository is performing work on that WorkUnit.

From the foregoing disclosure and detailed description of certain preferred embodiments, it is apparent that the management portal with object proxy provides improved management of shared computer networks such as, for example, wireless telecommunication networks having remote cell sites. It is further apparent that object proxy works seamlessly in two modes to provide both distributed method invocation (so that all of the plurality of servers receive a distributed method invocation from the client) and directed method invocation (so that a specific one of the plurality of servers receives a directed method invocation from the client). Thus, a method call or request can be distributed so every server on the network hears and responds or a specific server or specific servers on the network (less than all of the servers on the network) hears and responds. It is further apparent that object proxy seamlessly provides method request routing so that the directed method invocation is transparently routed to a correct one of the plurality of servers. This allows multiple servers to respond to the same request for different objects. For example, if you have two servers, one responsible for users with last names A-J and the other responsible for last names K-Z, a request to remove a user is transparently routed to the correct one of the servers depending on the user's last name. For example, routing tables can be provided for users so that the correct server can be determined by a look-up in the routing table. A pluggable routing layer can be sued for independent mapping to determine how to route the directed method invocations. It is further apparent that object proxy enables the remote method invocations to be protocol independent. The remote method invocations can be implemented over a plurality of application level transports such as, for example, JMS, RMI, XML-RPC, and the like. This solves the problem that untrustworthy or risky servers or devices are typically put into a “demilitarized zone” or DMZ where there are strict rules such as allowing no calls into the server. By being protocol neutral there is no problem with firewalls and can work in restricted network spaces. It can work by taking a method call and packaging it as a Java object and say it is a work unit. You have a pluggable transport layer. The caller is completely insulated so it is transport pluggable. It is further apparent that object proxy provides hybrid protocol support so that one of a plurality of different protocols is automatically selected for each remote method invocation. Preferably, protocol is determined on a method-by-method basis. The method invocation layer can be implemented such that some methods are invoked over a first protocol (such as, for example, RMI) while others are invoked over a second different protocol (such as, for example, XML-RPC) etc. A different protocol may be desired depending on the specific method. For example, a method requiring large data transfer may be best served with a protocol different from a method requiring little to no data transfer. The client and server can negotiate on the best protocol to use based on the Java contract (or interface). For example, the author of a library may include annotations about the method which give hints as to how best to transport. It is further apparent that object proxy provides protocol failover so that a different protocol is selected when the previously selected protocol fails. This remote method invocation layer provides protocol failover if services are not available. For example, if an attempt fails or there is not enough information about the network in order to make a decision about which protocol to choose, a preferred protocol or a list of protocols can be provided so that you work your way down the list upon failures and service cannot be fulfilled if everything on the list fails. It is further apparent that object proxy provides remote reference robustness. Unlike other Java RMI or other RPC-like technologies, a remote reference does necessitate a server socket. This is important when network connections are lost temporarily, IPs change, or network firewalls are introduced because a remote reference can survive these types of events. Object proxy permits the client to send remote references to the servers to call the client back so that a direct message is provided without requiring a server socket. Ordinarily, user may give instructions if, for example, a list changes call me to let me know and here is my remote reference. In this case, the server is acting like a client and receives calls from the client (which is acting like a server) to tell it about changes. However, in many networks this is restricted because you do not want remote devices getting calls from servers. Object proxy turns this back around by saying give me a call back using this identifier, and don't actually call. The server sends a generic message and IDs and the client sees them and recognizes them as its IDs. A directed message is received but it does not require opening a server socket on the client.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A shared computer network comprising, in combination:
a plurality of servers each having a server program which creates remote objects and makes references to the remote objects accessible;
a client having a client program which obtains the references to the remote objects and invokes methods on the remote objects; and
wherein the client program and the server program provide both distributed method invocation so that all of the plurality of servers receive a distributed method invocation from the client and directed method invocation so that a specific one of the plurality of servers receives a directed method invocation from the client.

2. The shared computer network of claim 1, wherein client and the server utilize a transport-independent remote procedure call (TI-RPC) system to pass information back and forth.

3. The shared computer network of claim 1, wherein client and the server utilize a distributive object application to pass information back and forth.

4. The shared computer network of claim 1, wherein the client program and the server program provide directed method request routing so that the directed method invocation is transparently routed to a correct one of the plurality of servers.

5. The shared computer network of claim 4, wherein the method request routing includes providing a routing table to determine how to route the direct method invocation.

6. The shared computer network of claim 1, wherein the remote method invocations can be protocol independent.

7. The shared computer network of claim 6, wherein the remote method invocations can be implemented over a plurality of application level transports.

8. The shared computer network of claim 1, wherein the client program and the server program provide hybrid protocol support so that one of a plurality of different protocols is automatically selected for each remote method invocation.

9. The shared computer network of claim 8, wherein the client program and the server program provide protocol failover so that a different protocol is selected when the previously selected protocol fails.

10. The shared computer network of claim 1, wherein the client program and the server program permit the client to send remote references to the servers to call the client back so that a direct message is provided without requiring a server socket on the client.

11. A shared computer network comprising, in combination:
a plurality of servers each having a server program which creates remote objects and makes references to the remote objects accessible;
a client having a client program which obtains the references to the remote objects and invokes methods on the remote objects;
wherein the client program and the server program provide directed method invocation so that a specific one of the plurality of servers receives a directed method invocation from the client; and
wherein the client program and the server program provide directed method request routing so that the directed method invocation is transparently routed to a correct one of the plurality of servers.

12. The shared computer network of claim 11, wherein client and the server utilize a transport-independent remote procedure call (TI-RPC) system to pass information back and forth.

13. The shared computer network of claim 11, wherein client and the server utilize a distributive object application to pass information back and forth.

14. The shared computer network of claim 11, wherein the method request routing includes providing a routing table to determine how to route the direct method invocation.

15. The shared computer network of claim 11, wherein the remote method invocations can be protocol independent.

16. The shared computer network of claim 15, wherein the remote method invocations can be implemented over a plurality of application level transports.

17. The shared computer network of claim 11, wherein the client program and the server program provide hybrid protocol support so that one of a plurality of different protocols is automatically selected for each remote method invocation.

18. The shared computer network of claim 17, wherein the client program and the server program provide protocol failover so that a different protocol is selected when the previously selected protocol fails.

19. The shared computer network of claim 11, wherein the client program and the server program permit the client to send remote references to the servers to call the client back so that a direct message is provided without requiring a server socket on the client.

20. A shared computer network comprising, in combination:
a plurality of servers each having a server program which creates remote objects and makes references to the remote objects accessible;
a client having a client program which obtains the references to the remote objects and invokes methods on the remote objects;
wherein the client program and the server program provide both distributed method invocation so that all of the plurality of servers receive a distributed method invocation from the client and directed method invocation so that a specific one of the plurality of servers receives a directed method invocation from the client; and
wherein the client program and the server program provide directed method request routing so that the directed method invocation is transparently routed to a correct one of the plurality of servers.
